(19) United States
(12) Patent Application Publication
(10) Pub. No.: US 2008/0216067 A1
(43) Pub. Date: Sep. 4, 2008

(54) Arrangement and Method for Programming Motor Vehicles

(75) Inventor: Bjorn Villing, Landvetter (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/909,804

(22) PCT Filed: Apr. 4, 2005
(86) PCT No.: PCT/SE2005/000492

§ 371 Date: Sep. 27, 2007

(51) Int. Cl. G06F 9/445

(52) U.S. Cl. 717/174

(57) ABSTRACT

A reprogrammable system arranged in a motor vehicle includes a data network that connects a plurality of control-units arranged in the vehicle for controlling vehicle systems. At least a first control-unit of the control-units is provided with a reprogrammable memory for storing software, which directs the first control-unit in controlling a vehicle system that is connected to the first control-unit. At least a second control-unit of the control-units is connected to a media-receiver adapted to receive a portable media, which includes software to be installed in the memory of the first control-unit. The second control-unit is further arranged to obtain the software from the portable media and to transfer the software to the first control-unit. A method for reprogramming an ECU by using the reprogrammable system arranged in a motor vehicle is also provided.

### FIELD OF THE INVENTION

Generally the present invention relates to installation of software in a motor vehicle. In particularly the invention relates to installation of software in an ECU (Electronic Control Unit) or similar utilized to control the functioning of various hardware and software in the motor vehicle. More specifically, the invention relates to an arrangement and a method for reprogramming an ECU while it remains mounted in the motor vehicle.

Modern motor vehicles provide many software-controlled features or functions to accommodate the needs and desires of drivers and passengers and to comply with the regulation of governmental agencies. Higher end automobiles, sport utility vehicles and trucks tend to provide an increasing number of such features to accommodate the occupants. These features are generally controlled by software that is programmed into the memory or similar of various modules or Electronic Control Units (ECUs) located at different places within the vehicle. The ECUs and the signal paths to and from the ECUs and the hardware devices they control can be thought of as forming a high-speed data network that is included within the vehicle.

The main systems in a modern motor vehicle are typically provided with at least one of these ECUs or similar. For example, the internal combustion engine of a motor vehicle may be controlled by at least one ECU provided with the suitable software for adjusting the fuel delivery system and/or the ignition system. Similarly, the Anti-Lock Braking System (ABS) of a vehicle may be controlled by an ECU provided with the suitable software for adjusting the braking action of the brakes of the vehicle depending on variables such as the vehicle speed, the weight of the vehicle and the property of the vehicle chassis etc. Another ECU may e.g. be provided with the suitable software for controlling the light system within the passenger compartment, e.g. so as to illuminate the entry or exit when a door is opened and/or so as to dim the light in the passenger compartment when the doors are closed etc. Many other software-operated ECUs may be utilized in modern vehicles.

However, software and data available during development and manufacturing of an ECU may later be improved, it is then difficult to change the programs in ECUs that are already on the market. For example, it is usually a complicated and time-consuming task to recall vehicles having ECUs provided with old software and rewrite their memories. Therefore, fresh or new data cannot easily be used for ECUs in vehicles which have already been manufactured. Consequently, vehicles having ECUs provided with control data of old models can not easily enjoy the advantages of the latest software in respect of fuel cost, emission control measures, environmental preservation, etc. This is so despite the fact that old ECUs may be quite the same in hardware as those of new models.

A reprogramming may e.g. require that the entire ECU or at least a memory within the ECU is removed from the vehicle, which typically involves the removing of an integrated circuit or similar comprising the ECU or the memory of the ECU. Removing such units from the vehicle results in an undesirable expenditure of time and it increases the risk of damaging the vehicle and/or the unit, e.g. by an accidental bending of the electrical contacts of the unit. Removing an electronic unit from the vehicle may also injure the unit due to electrical discharges into the contacts of the unit, e.g. due to discharge of static electricity.

However, some ECUs may have a design that allow a reprogramming by means of wire or wireless transmission, which implies that neither the ECU nor any unit within the ECU have to be removed from the vehicle.

Programming or reprogramming by wire transmission typically requires a suitable programming-equipment that is provided with the software or similar to be installed in the ECU. The equipment is typically connected to the ECU via a cable that is inserted into a contact arranged in the vehicle. These contact assemblies are exposed to damages, intermittent contact (e.g. caused by corrosion) etc. A contact assembly may also be exposed to the risk of an incorrect handing, e.g. an incorrect insertion of the cable or an incorrect mounting/dismounting of a protective cover etc. Nevertheless, reprogramming by wire may be acceptable in a factory during production of a vehicle or even in a workshop during service and repair of a vehicle. Chances are good that these sites have access to the required programming-equipment and persons skilled to operate such equipment. However, there are a range of sites and situations in which neither the required equipment nor persons skilled to operate such equipment can be obtained. For example, it can be assumed that many car resellers and car owners do not have access to the required programming-equipment, particularly not a programming-equipment provided with the appropriate software. It can also be assumed that many car resellers and car owners do not have the necessary skill to operate such a programming-equipment. Consequently, reprogramming of an ECU by wire transmission typically requires that the reprogramming is performed at certain locations with access to the necessary programming-equipment and persons skilled to operate such equipment.

Turning to programming or reprogramming by wireless transmission this—similar to reprogramming by wire—typically requires a suitable programming-equipment that is provided with the particular software or similar to be installed in the ECU. The programming-equipment is typically connected to the ECU via a wireless transmission link or similar. The wireless link can e.g. be established between a first transceiver connected to the programming-equipment and a second transceiver connected to the ECU and preferably arranged in the vehicle. The wireless transmission may e.g. be executed by means of GSM, GPRS, CDMA, WCDMA, Bluetooth, WLAN or any other suitable wireless system. A reprogramming by wireless transmission offers some improvements compared to reprogramming by wire transmission. For example, a wireless connection does not require any cable or contact assembly or similar for connecting the programming-equipment to the ECU, which cable or contact assembly are exposed to damages, corrosion, intermittent contact, incorrect insertion etc. However, a wireless transmission presupposes that the transceiver in the programming-equipment and the transceiver connected to the ECU are positioned within range of each other. Consequently, if the vehicle and the programming-equipment are positioned or moved out of range from each other this will disturb the transmission, i.e. preclude any transmission and/or disturb an ongoing transmission causing an erroneous reprogramming. Moreover, a wireless transmission is susceptible to interferences from other sources transmitting on the same frequency. A wireless transmission is also affected by objects that are located between the transceivers or similar, e.g. objects in the terrain or manufactured objects such as walls provided with reinforcement bars etc. As a contrast, when using a wire transmission the length of the cable or similar will effectively define the range within which the programming-equipment and the vehicle can be moved. Hence, the risk of being out of range is effectively eliminated. A cable transmission is also less susceptible to interferences.

Considering the risk for damages and faulty handling when reprogramming an ECU by removing an unit; and considering the need for a programming-equipment and the skill required to operate this equipment when reprogramming an ECU by wire or wireless transmission and particularly considering the need for certain sites provided with said equipment and said skill, and the need for a certain position or a certain geographical location of said equipment and said ECU, there is a need for an improved system and an improved method for reprogramming an ECU. In particular, there is a need for a system and a method for reprogramming an ECU or similar that is truly portable, which system and method requires a minimum of skill to use.

An aspect of the invention provides for an improved method for reprogramming an ECU or similar, in particular, a system and a method that is truly portable and which requires a minimum of skill to use. This is accomplished by a reprogrammable system arranged in a motor vehicle comprising a data network that connects a plurality of control-units, which are arranged in said vehicle for controlling vehicle systems. At least a first control-unit of said control-units is provided with a reprogrammable memory for storing software, which directs the control-unit in controlling a vehicle system that is connected to the control-unit. At least a second control-unit of said control-units is connected to a media-receiver adapted to receive a portable media, which comprises software to be installed in the memory of said first control-unit. Said second control-unit is further arranged to obtain said software from said portable media and to transfer said software to said first control-unit.

It is preferred that said media-receiver is a CD-player or a DVD-player or a combined CD/DVD-player or similar arranged within the passenger compartment of said vehicle, and that said portable media is a CD-ROM or a DVD-ROM or similar. It is even more preferred that said CD-player, DVD-player or combined CD/DVD-player is a part of a more complex multimedia equipment.

It is also preferred that said second control-unit is arranged to obtain a vehicle identification item from a received media (150); and to compare the obtained item with a vehicle identification item stored in the vehicle; and to only transfer said software if the obtained item corresponds to the vehicle identification item stored in the vehicle.

Additionally, it is preferred that said second control-unit is arranged to obtain a personal identification item—e.g. a PIN-code or a biometric item—from a person performing a reprogramming; and to compare the obtained item with a personal identification item stored in the vehicle or on the media; and to only transfer said software if the obtained item corresponds to the personal identification item stored in the vehicle or on the media.

Additionally it is preferred that said second control-unit (14) is arranged to determine whether the obtained software (151) is compatible with the software already installed in the vehicle; and to only transfer the obtained software if it is compatible with the software already installed.

An aspect of the invention also comprises a method for reprogramming an ECU or similar by using said reprogrammable system arranged in a motor vehicle.

Further advantages of the present invention and embodiments thereof will appear from the following detailed description.

### BRIEF DESCRIPTION OF THE DRAWINGS

FIG. 1 shows a schematic illustration of a perspective illustration of a reprogrammable vehicle system and a preferred media for storing software to be installed in an ECU; and

FIG. 2 shows a flowchart of an exemplifying installation procedure.

### DETAILED DESCRIPTION

In the following an aspect of the invention will be described in more detail with reference to an exemplifying reprogrammable system arranged in a motor vehicle and with reference to a method for using that system. Other aspects of the invention are clearly conceivable and the invention is by no means limited to the exemplifying reprogrammable system or method as described below.

A Reprogrammable System

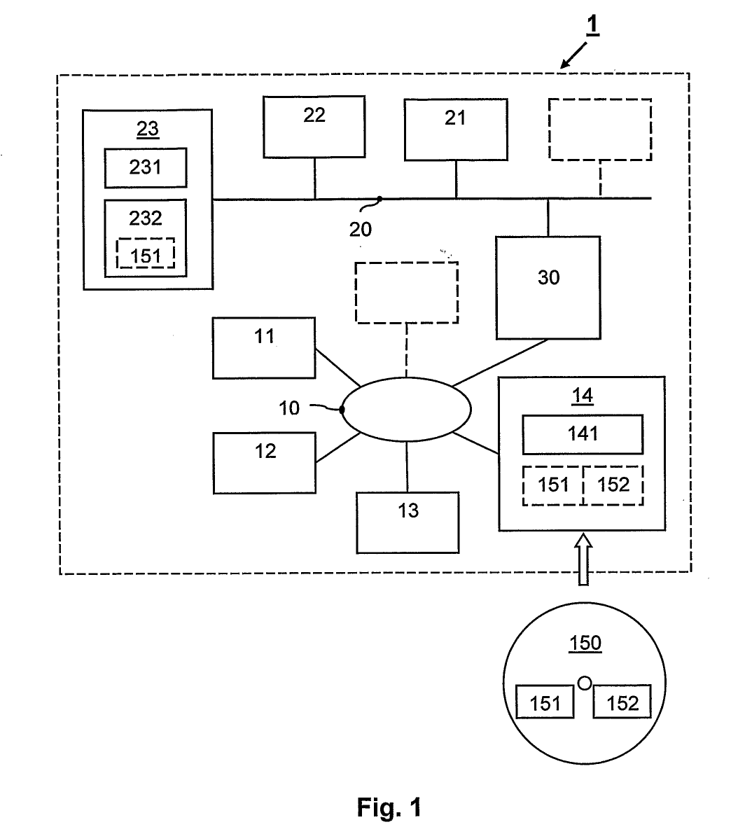

Turning to FIG. 1, a preferred embodiment of a reprogrammable vehicle system 1 is shown. The reprogrammable vehicle system 1 comprises a first data network 10 providing a high bandwidth for connecting a plurality of devices and applications or similar which typically exchange large quantities of data. Examples of such devices may be: an ECU 11 that transmits and receives high-speed communication to and from external sources, e.g. an external WLAN or possibly an external UMTS network or similar; or an ECU 12 that receives and distributes various images to a screen (not shown) connected to the ECU 12 for assisting a driver of the vehicle; or an ECU 13 that distributes an image from a rearward-looking video camera (not shown) connected to said ECU 13, e.g. distributing the image to the ECU 12 and the screen connected thereto for assisting a driver reversing the vehicle; or an ECU 14 distributing/receiving information from/to multimedia sources such as a CD/DVD-player (not shown) or similar connected to said ECU 14. The CD/DVD-player or similar may be part of a more complex multimedia equipment (not shown) comprising further functions such as a radio-receiver, a TV-receiver or similar connected to or included in said ECU 14. In particular it is preferred that said ECU 14 is arranged to receive information from a CD/DVD-ROM or similar inserted in said CD/DVD-player and further arranged to distribute the received information to the data network 10 and the ECUs or similar connected to said data network 10.

In addition, the preferred reprogrammable vehicle system 1 in FIG. 1 comprises a second data network 20 having a lower bandwidth for connecting a plurality of devices or applications or similar which typically exchange smaller quantities of data, e.g. control signals or measurement values etc. Examples of such devices may be an ECU 21 controlling the vehicle dashboard and/or the instrument cluster, an ECU 22 controlling the vehicle brakes or an ECU 23 controlling the vehicle motor etc.

The first data network 10 providing a high bandwidth is preferably a Media Oriented Systems Transport (MOST) network. The basic principles of the MOST Technology were originally developed by OASIS SiliconSystems AG in cooperation with BMW AG, DaimlerChrysler AG and Becker Automotive Systems GmbH (see www.mostcooperation.com). The MOST-standard defines the protocol, hardware, and software layers to allow for transport of control, real-time, and packet data in a very efficient and low cost way using a single medium (e.g. fiber optics). Transmission rates of 15 Mbit/s asynchronous data and 24.5 Mbit/s synchronous (future versions up to 150 Mbit/s) data are available.

The second data network 20 providing a lower bandwidth is preferably a Controller Area Network (CAN). The CAN-standard was originally developed by Robert Bosch GmbH in the mid 1980s for use in the passenger car industry to provide a cost-effective communications bus for in-car electronics and as alternative to expensive and cumbersome wiring looms (see www.can.bosch.com). The CAN-bus is a serial communications bus for real-time control applications. A CAN-bus operates at data rates of up to 1 Mbits/s and has excellent error detection and confinement capabilities. The CAN-standard is documented in ISO 11898 (for high-speed applications) and ISO 11519 (for lower-speed applications). Anti-lock braking systems, engine management systems, traction control systems and air conditioning control systems are some examples of systems that can be connected by means of a CAN-bus. Each of these systems is typically controlled by one or several ECUs.

Even if the first data network 10 in FIG. 1 may be a MOST-network arranged in a ring topology and even if the second data network 20 in FIG. 1 may be a CAN arranged in a bus topology it should be emphasised that other suitable networks and other suitable topologies may be used without departing from the present invention.

The exemplifying first data network 10 and the exemplifying second data network 20 in FIG. 1 are preferably connected by a gateway module 30 as shown in FIG. 1. The gateway module 30 performs a bidirectional translation of electrical levels and data protocols between the first data network 10 and the second data network 20, which enables a seamless communication between the units 11-14 in the first data network 10 and the units 21-23 in the second data network 20. For example, the ECU 14 controlling multimedia equipment such as a CD/DVD-player and the ECU 23 controlling the vehicle motor can exchange information via the gateway 30. However, alternative aspects of the invention may have a single data network that connects all ECUs 11-14 and 21-23, which obviates the need for a gateway module 30, whereas other embodiments may have three or more data networks, which may require two or more gateways.

A Reprogrammable ECU

It is preferred that a reprogrammable ECU according to an exemplifying embodiment of the present invention is provided with a flash-memory or some other suitable Electrical Erasable Programmable Read Only Memory (EEPROM) or similar. Additionally, it is preferred that the reprogrammable ECU is provided with a software loader, which is arranged to receive new software and arranged install that software in said memory of the ECU.

Accordingly, the ECU 23 in FIG. 1 comprises a software-loader 231 and a flash-memory 232. The software-loader 231 is arranged to receive new ECU software via the data network 20 and further arranged to install that software in the flash-memory 232 of the ECU, as will be explained in more detail below. The software-loader 231 may be implemented in software or hardware, or a combination of software and hardware. The flash-memory 232, as most modern flash-memories, allows a separation of the memory into segments, which can be separately erased and written-to. A piece of software which fits into such a memory segment and which can be loaded and installed by the software-loader 231 is called a software-module 151. The software of an ECU may comprise one or several such software-modules 151.

A Reprogramming Device and a Software-Media

The reprogramming of an ECU is preferably managed by an onboard software-component. It is preferred that the software-component resides in an ECU of the vehicle having sufficient memory and processing power, as well as good connectivity to the data networks 10, 20 connecting the various vehicle ECU and to the media from which to receive the software to be installed.

Accordingly, the ECU 14 in FIG. 1 comprises a reprogramming controller 141 or similar. In addition, it is preferred that the ECU 14 is connected to a CD/DVD-player (not shown) for receiving a CD/DVD-ROM 150 or similar comprising the software to be installed in one or several target ECUs, e.g. the ECU 23. The insertion of a CD/DVD-ROM 150 in the CD/DVD-player (not shown) connected to the ECU 14 has been schematically illustrated by an arrow pointing from the CD/DVD-ROM 150 towards the ECU 14 in FIG. 1.

The reprogramming controller 141 in the ECU 14 is preferably implemented in software, though an implementation in hardware or a combination of software and hardware is not excluded. It is preferred that the reprogramming controller 141 comprises the functions for; retrieving and/or receiving the software from the CD/DVD-ROM, checking the received software 151 for compatibility with the software already installed in the vehicle, transferring the appropriate software to the appropriate ECU(s) and also the functions for supervising and validating the installation of said software.

The CD/DVD-player is arranged to read the information stored on the CD/DVD-ROM 150 and make the data available to the ECU 14. It is preferred that the CD/DVD-player is part of a more complex multimedia equipment (not shown) arranged in the passenger compartment of the vehicle.

In addition it is preferred that the software to be installed on one or several ECUs and which is stored on the CD/DVD-ROM comprises the software-module(s) 151 to be installed and the associated configuration-data 152 containing the information required for the installation of the software-module(s) 151 on the target ECU or ECUS—for example, start addresses and lengths of the individual segments of a software-module 151 , and checksums of the software-module(s) 151 etc.

Installation of New Software-Modules

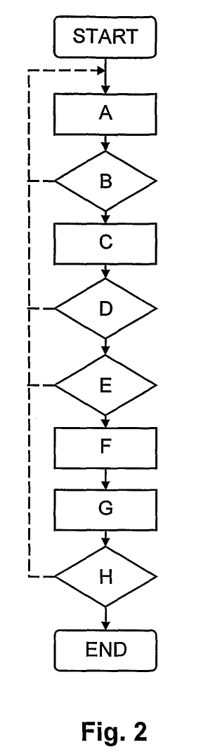

Turning to FIG. 2, a flowchart of an exemplifying installation procedure is shown. As illustrated by step A it is preferred that the installation of a software-release is initiated by the insertion of a CD/DVD-ROM into a CD/DVD-player that is connected to the ECU 14. The CD/DVD-player reads the information stored on the inserted CD/DVD-ROM and makes it available to the ECU 14.

As illustrated by step B in FIG. 2 the installation procedure will be terminated if the reprogramming controller 141 in the ECU 14 cannot detect any software-modules 151 on the inserted CD/DVD-ROM. This is typically so for CD/DVD-ROMs containing music, movies or other infotainment information or similar, in which case the reprogramming controller 141 may nevertheless continue by e.g. activating a multimedia function or similar in the ECU 14. The installation procedure may also be terminated if the reprogramming controller 141 cannot detect an identification number or similar on the CD/DVD-ROM that is identical to the unique Vehicle Identification Number (VIN) or similar allocated to the vehicle during manufacturing or later. This ensures that a CD/DVD-ROM cannot be used for other vehicles than the vehicle it was intended for, which raises the safety level as a reprogramming is more likely to be executed in a correct vehicle environment. This should also reduce the risk for piracy copying of valuable software. If the installation process has been terminated it may be repeated, as illustrated by a dashed line in FIG. 2. However, if the inserted CD/DVD-ROM contains at least one software-module 151 and the configuration-data 152 required for installing this software-module 151 and if the CD/DVD-ROM is appropriate the installation procedure will proceed to the next step.

Prior to the installation of a new software release the content of the software-module(s) 151 and the content of the corresponding configuration-data 152 are transferred to the reprogramming-controller 141 in the ECU 14. This is illustrated by step C in FIG. 2. As previously explained; a software-module 151 is a piece of software which fits into a memory segment of a flash-memory or similar in the target ECU, and the configuration-data 152 is the data needed for installing the software-module 151 in said flash-memory. As previously indicated, the configuration-data 152 may e.g. comprise such information as checksums or similar for the software-module(s) 151 to be installed, identification numbers of the software-modules that have to be removed from an ECU(s) to be reprogrammed and the number of software-modules 151 to be installed etc.

After receiving the software-module(s) 151 and the corresponding configuration-data 152 the installation procedure proceeds to step D, in which step the reprogramming-controller 141 determines whether the received software—i.e. the received software-module(s) 151 and configuration-data 152—is compatible with the software already installed in the vehicle, in particularly the software-modules installed in the ECUs of the vehicle. An incompatible software configuration might lead to an undesirable behaviour of the vehicle. The reprogramming-controller 141 will therefore terminate the installation procedure if the software is incompatible or proceed to the next step E in the installation procedure if the software is compatible. If the installation process has been terminated it may be repeated, as illustrated by a dashed line in FIG. 2.

In step E the reprogramming-controller 141 verifies that the motor vehicle is in a state where reprogramming is possible. Typically this includes the step of verifying that the vehicle motor has been turned off, even though reprogramming with the motor running may be an alternative in some embodiments. In addition, security reasons support that an unauthorized person should not be able to reprogram a vehicle, even if that person has retrieved a CD/DVD-ROM or similar that can be used for reprogramming the specific vehicle. It is therefore preferred that the authorization of the person performing the reprogramming is verified, which e.g. may be accomplished by requesting that said person enters a PIN-code or some other identification item on a suitable keyboard or touch screen or similar connected to the ECU 14. Another suitable identification item may be a fingerprint or some other biometric item that is entered by said person on a biometric reader or similar connected to the ECU 14. The reprogramming-controller 141 in ECU 14 may then compare the entered PIN-code or biometric item or similar with a corresponding authorized identification item stored in the vehicle (e.g. in the ECU 14) and/or on the inserted CD/DVD-ROM. If the conditions verified by the reprogramming controller 141 are met—e.g. that said motor is turned of and that said person is authorized—the installation procedure will continue to the next step F. However, if the conditions are not met the installation procedure will be interrupted. If the installation process has been terminated it may be repeated, as illustrated by a dashed line in FIG. 2.

In an embodiment of the method, it is also possible to display the content of the software upgrades available on a display. This makes it possible for an operator to select between different options or different versions of the upgrades. This can also be advantageous when new features are to be installed. The operator can then select only the features that should be updated or installed. The operator selects the software modules in the list displayed, preferable in the built-in menu system of the vehicle.

In the next step F a transition to the “reprogramming” state takes place. From this point on the vehicle contains an invalid software configuration until the installation has been successfully completed. It is preferred that the vehicle cannot be started while it contains an invalid software configuration. The reprogramming-controller 141 transmits the software-module(s) 151 and the appropriate configuration-data 152 to the destination ECU via the data network 10 and/or 20. The destination ECU is illustrated by the ECU 23 in FIG. 2, in which the software-module(s) 151 and the configuration-data 152 are received by the software-loader 231, which in turn installs the received software-module(s) 151 in the flash memory 232 of the destination ECU 23.

In the next step G a checksum or similar is calculated when all software-modules 151 have been installed, which enables a subsequent test whether the installed software-modules 151 form a valid software configuration. A checksum may be calculated for all software-module(s) 151 in a single ECU to verify that the software configuration in that ECU is a valid configuration. However, a checksum may alternatively be calculated for a plurality of ECUs to verify that the combined software configuration of these ECUs constitutes a valid software configuration. A checksum for the software-module(s) 151 in a single ECU is preferably calculated by a software-loader or similar in the specific ECU—e.g. as the software-loader 231 in the target ECU 23. It is also preferred that the software-loader 231 transmits the checksum or similar to the reprogramming controller 141 in the ECU 14

In the next step H the reprogramming controller 141 determines if the software configuration of a single ECU is valid and/or if the software configuration of a plurality of ECUs is valid. If the checksum(s) or similar confirms that the installed software configuration is valid then the installation procedure ends successfully and the reprogramming state is lifted, which i.a. means that the vehicle may be started again. However if the checksum(s) or similar confirms that the installed software configuration is invalid then the installation procedure terminates unsuccessfully and the reprogramming state is maintained. The installation procedure can then be repeated as illustrated by a dashed line in FIG. 2, which may lead to a success if the previous attempt was affected by a temporary disturbance or similar.

From the above it should be clear that by using a reprogrammable vehicle system 1 and a CD/DVD-ROM 150 or a similar portable media with the appropriate software 151, 152 for reprogramming an ECU 23 in said vehicle system 1 the risk of damaging the vehicle and the risk of a faulty handling during reprogramming can be minimized. In addition, this eliminates the need for a separate reprogramming-equipment and the reprogramming is therefore not confined to sites with access to such equipment and persons skilled to operate it. Likewise, a reprogramming by a portable media is not confined to certain positions or geographical locations, as is the case for a reprogramming-equipment which has to be within range of the ECU to be reprogrammed, e.g. within cable range or wireless range.

The present invention has now been described by means of exemplifying embodiments; in particular embodiments comprising a preferred vehicle data network 10, 20 for connecting exemplifying ECUs and preferred steps for reprogramming said exemplifying ECUs. However, the invention is not limited to the embodiments described above. On the contrary, other networks and configurations are clearly conceivable and the steps for reprogramming an ECU or similar are by no means exhaustive. Some steps or at least part of some steps may also be excluded and the steps may be performed in another order without departing from the invention.

Reference Signs
1 Reprogrammable Vehicle System
10 First Network (MOST)
11 ECU
12 ECU
13 ECU
14 Multimedia-ECU
20 Second Network (CAN)
21 ECU
22 ECU
23 Reprogrammable ECU
30 Gateway Module
141 Reprogramming controller
150 CD/DVD-ROM
151 Software-Module
152 Configuration-Data
231 Software-Loader
232 Flash-Memory

1. A reprogrammable system in a motor vehicle comprising:
a data network connecting a plurality of control-units arranged in the vehicle for controlling vehicle systems, wherein at least a first control-unit is provided with a reprogrammable memory for storing software that directs the first control-unit in controlling a vehicle system connected to the first control-unit, wherein
at least a second control-unit of the control units is connected to a media-receiver adapted to receive a portable media comprising software to be installed in the memory of the first control-unit; and
the second control-unit is further arranged to obtain the software from the portable media and to transfer the software to the first control-unit.

2. A programmable system according to claim 1, wherein the media-receiver is a CD-player or a DVD-player or a combined CD/DVD-player arranged within the passenger compartment of the vehicle, and the portable media is a CD-ROM or a DVD-ROM.

3. A programmable system according to claim 2, wherein the CD-player, DVD-player or combined CD/DVD-player is a part of a multimedia equipment arrangement.

4. A programmable system according to claim 1, wherein a reprogramming controller is arranged in the second control-unit to transfer the software to the control-unit.

5. A programmable system according to claim 4, wherein the reprogramming controller is arranged to install the transferred software in the memory (232).

6. A programmable system according to claim 1, wherein a software-loader is arranged in the first control-unit to install the transferred software in the memory.

7. A programmable system according to claim 1, wherein the second control-unit is arranged to:
obtain a vehicle identification item from a received media; and
compare the obtained item with a vehicle identification item stored in the vehicle; and
only transfer the software if the obtained item corresponds to the vehicle identification item stored in the vehicle.

8. A programmable system according to claim 1, wherein the second control-unit is arranged to:
obtain a personal identification item from a person performing a reprogramming; and
compare the obtained item with a personal identification item stored in the vehicle or on the media; and.
only transfer the software if the obtained item corresponds to the personal identification item stored in the vehicle or on the media.

9. A programmable system according to claim 8, wherein the second control-unit is arranged to:
determine whether the obtained software (151) is compatible with the software already installed in the vehicle; and
only transfer the obtained software if it is compatible with the software already installed.

10. A method for reprogramming a system in a motor vehicle, which system comprises a data network connecting a plurality of control-units arranged in the vehicle for controlling vehicle systems, wherein:
at least a first control-unit is provided with a reprogrammable memory for storing software that directs the first control-unit in controlling a vehicle system connected to the first control-unit;
at least a second control-unit is connected to a media-receiver adapted to receive a portable media comprising software to be installed in the memory of the first control-unit; which second control-unit is further arranged to obtain the software from the portable media and to transfer the software to the first control-unit,
the method comprising:
inserting the portable media in the media receiver;
inducing the second control-unit to obtain the software from the portable media;
inducing the second control-unit to transfer the software to the first control-unit.

11. A method according to claim 10, comprising
inserting a CD-ROM or a DVD-ROM comprising the software in at least one of a CD-player, a DVD-player or a combined CD/DVD-player connected to the second control-unit and arranged in the passenger compartment of the vehicle.

12. A method according to claim 11, wherein
the at least one of a CD-player, a DVD-player or a combined CD/DVD-player is part of a multimedia equipment arrangement.

13. A method according to claim 10, comprising
obtaining a vehicle identification item from a received media; and
comparing the obtained item with a vehicle identification item stored in the vehicle; and.
only transferring the software if the obtained item corresponds to the vehicle identification item stored in the vehicle.

14. A method according to claim 10, comprising
obtaining a personal identification item from a person performing a reprogramming; and
comparing the obtained item with a personal identification item stored in the vehicle or on the media; and.
only transferring the software if the obtained item corresponds to the personal identification item stored in the vehicle or on the media.

15. A programmable system according to claim 14, comprising
determining whether the obtained software is compatible with the software already installed in the vehicle; and
only transferring the obtained software if it is compatible with the software already installed.
